(19) United States
(12) Patent Application Publication
(10) Pub. No.: US 2004/0249093 A1
(43) Pub. Date: Dec. 9, 2004

(54) Polyolefins with high levels of long chain branching

(76) Inventors: Michael W. Lynch, West Chester, OH (US); Manivakkam J. Shankernarayanan, Cincinnati, OH (US)

Correspondence Address: BROOKS KUSHMAN P.C., 1000 TOWN CENTER, TWENTY-SECOND FLOOR, SOUTHFIELD, MI, 48075, US

(21) Appl. No.: 10/457,769

(22) Filed: Jun. 9, 2003

(51) Int. Cl. C08F 4/44

(52) U.S. Cl. 526/128; 526/348.2; 526/348.5; 526/348.6; 526/129

(57) ABSTRACT

The present invention provides a method of forming a polyolefin resin having a relatively high densities and a long chain branch index (“LCB”) greater than about 1. The method of the invention comprises forming a reaction mixture by combining molecular hydrogen, a first olefin, an optional second olefin, a diluent, and a vanadium-containing catalyst system at a sufficient temperature to allow formation of the polyolefin resin and initiating polymerization of the reaction mixture.

### BACKGROUND OF THE INVENTION

1. Field of the Invention

The present invention is related to methods of making polyolefin resins having densities greater than 0.92 g/cm³ and high levels of long chain branching.

2. Background Art

Polyolefins, and in particular polyethylene, are important thermoplastic resins used in a multitude of applications. Polyethylene is perhaps the best known and most widely used thermoplastic in the world. A molecule of polyethylene consists of a long chain of —CH₂— groups. There are several different types of polyethylene each having different properties—Low Density Polyethylene (“LDPE”), Linear Low Density Polyethylene (“LLDPE”), Medium Density Polyethylene (“MDPE”), and High Density Polyethylene (“HDPE”). The various types of polyethylene characteristically differ in density. LDPE has a relatively low density from about 0.91 to 0.925 grams/cm³; LLDPE has a low relative density: 0.91 to 0.925 grams/cm³; MDPE has a density for about 0.926 to 0.94 grams/cm³; and HDPE has a density from about 0.941 to 0.965 grams/cm³. Both HDPE and LLDPE tend to have superior mechanical properties to LDPE. However, HDPE tends to tear more easily than LDPE.

LDPE is characterized by having a branched structure that contains long chain branches. This branched structure gives LDPE several useful properties which include for example transparency, low density, and flexibility. A second important advantage of long chain branching is that such branching improves melt strength and facilitates processing. Moreover LDPE is useful in extrusion and rotational molding processes. LDPE finds application in forming plastic bags, bottles, and in electrical applications. However, LDPE resins are typically made by an expensive high pressure (20 to 30,000 psig) process.

Linear Low Density Polyethylene (“LLDPE”) is another type of polyethylene which differs from LDPE in several characteristics. The usual type of LLDPE usually does not contain significant amounts of long chain branching instead, LLDPE usually has only short chain branching. Short chain branching (“SCB”) is defined as a short chain coming off the main polymer backbone having a length of two carbons less than the length of the comonomer. Long chain branching (“LCB”) refers to much longer chains coming off of the polymer backbone comprising a significant number of monomer units. Moreover, a significant difference between LLDPE and HDPE is that the lower amounts of short chain branches in HDPE results in higher density material. The differing linearity of LLDPE results from the different manufacturing processes of LLDPE and LDPE. LLDPE is typically produced at much lower temperatures and pressures, by co-polymerization of ethylene with butene, hexene or octene. The co-polymerization process produces a polymer that has a narrower molecular weight distribution than LDPE and significantly different theological properties. The molecular weight distribution in LLDPE has significant effect on such properties as chemical resistance, permeability, tensile strength, stiffness, and environment stress-crack resistance. The density of LLDPE is determined by the concentration of the co-monomer in the polyethylene chain. The higher the co-monomer concentration, the lower the density of the resin.

Although many variations of polyolefins, and in particular polyethylene are known, currently there are few if any polyolefins that achieve even moderately high densities (i.e., greater than about 0.92) with high values of the long chain branching index (1 to 6.)

### SUMMARY OF THE INVENTION

Against this prior art background, the present invention provides a polyolefin resin having a relatively high density and a long chain branch (“LCB”) index greater than about 1. This combination of properties has not previously been shown in polyolefin resins made in a low pressure process without the use of a chromium-based catalyst, and in particular polyethylene resins. The polyolefin resin of the present embodiment comprises a polymer resin formed by the polymerization of a first olefin selected from the group consisting of ethylene and C₃-C₈ α-olefin and an optional second olefin which is different than the first olefin selected from the group consisting of ethylene and C₃-C₈ α-olefin. The polymer resin has a density greater than about 0.92, a melt index from about 0.01 to about 20, and a long chain branching index of greater than about 1.

In another embodiment of the present invention, a method of forming a polyolefin resin with a relatively high density and a long chain branch index greater than about 1. The method for the invention comprises forming a reaction mixture at a sufficient temperature to allow formation of the polyolefin resin by combining molecular hydrogen, a first olefin selected from the group consisting of ethylene and C₃-C₈ α-olefin, an optional second olefin which is different than the first olefin selected from the group consisting of ethylene and C₃-C₈ α-olefin, a diluent, and a catalyst system that forms long chain branches on a polymer backbone and initiating polymerization of the reaction mixture. The resulting polyolefin resin has a density greater than about 0.92, a melt index from about 0.01 to about 20, and a long chain branching index greater than about 1. The preferred catalyst system is disclosed in U.S. Pat. No. 5,534,472.

### DETAILED DESCRIPTION OF THE PREFERRED EMBODIMENT(S)

Reference will now be made in detail to presently preferred compositions or embodiments and methods of the invention, which constitute the best modes of practicing the invention presently known to the inventors.

In an embodiment of the present invention, a polyolefin resin with high levels of long chain branching is provided. The polyolefin resin of the present embodiment comprises a polymer resin formed by the polymerization of a first olefin selected from the group consisting of ethylene and C₃-C₈ α-olefin and an optional second olefin which is different than the first olefin selected from the group consisting of ethylene and C₃-C₈ α-olefin. The polymer resin has a density greater than about 0.92, a melt index from about 0.01 to about 20, and a long chain branching index of greater than about 1. In one variation of this embodiment, the melt index is from about 0.1 to 10. In another variation of this embodiment, the long chain branching index is from about 1 to 6. In still another variation of this embodiment, the long chain branching index is from about 2 to 3. The preferred methods of making the polymer resin of this embodiment are the methods of the invention set forth below.

The polyolefin resins of the present invention advantageously have high values of the long chain branching index (“LCBI”). The derivation of the long chain branching index is discussed in the article Long-Chain-Branching Index for Essentially Linear Polyethylenes, R. N. Shroff and H. Mavridis, Marcomolecules, vol. 32, no. 25, p. 8454-8464, (1999). The long chain branching index is related to the viscosity enhancement from long chain branching. It is independent of molecular weight and molecular weight distribution. The long chain branching index is given by:

LCBI=(η₀^{0.179}/(4.8[η]))−1

where η₀ is the shear viscosity at 190° C. and [η] is the intrinsic viscosity in trichlorobenzene at 135° C.

The first olefm and the second olefin are each selected from the group consisting of ethylene, propylene, 1-butene, 1-pentene, 4-methyl-1-pentene, 1-hexene, 1-octene, and mixtures thereof with the proviso that the first olefin and the second olefin are different. Preferably, the first olefin is ethylene. Typically, the molar ratio of the first olefin to the second olefin is from about 0.001 to about 1,000 in the reaction mixture. Moreover, the first olefin is present in an amount of about 0.2 mole % to about 20 mole % of the reaction mixture and the second olefin is present in an amount of about 0.1 mole % to about 30 mole % of the reaction mixture. Furthermore, the polymerization may include molecular hydrogen in an amount of about 0.00005 mole % to about 5 mole % of the reaction mixture. In a first variation of this embodiment, the first olefin is present in an amount of about 5 mole % to about 15 mole % of the reaction mixture and the second olefin is present in an amount of about 0.5 mole % to about 5 mole % of the reaction mixture. In this first variation, first olefin is ethylene, the second olefin is selected from the group consisting of ethylene, propylene, 1-butene, 1-pentene, 4-methyl-1-pentene, 1-hexene, 1-octene, and mixtures thereof, and the polyolefin resin is a HDPE. In a second variation of this embodiment, the first olefin is present in an amount of about 5 mole % to about 15 mole % of the reaction mixture and the second olefin is present in an amount of about 5 mole % to about 30 mole % of the reaction mixture. In this second variation, the first olefin is ethylene, the second olefin is selected from the group consisting of ethylene, propylene, 1-butene, 1-pentene, 4-methyl-1-pentene, 1-hexene, 1-octene, and mixtures thereof, and the polyolefin resin is a LLDPE.

In another embodiment of the present invention, a method of forming a polyolefin resin is provided. The method of this embodiment comprises:

a) forming a reaction mixture at a sufficient temperature to allow formation of the polyolefin resin by combining molecular hydrogen, a first olefin selected from the group consisting of ethylene and C₃-C₈ α-olefin, an optional second olefin selected from the group consisting of ethylene and C₃-C₈ α-olefin, a diluent, and a catalyst system; and

b) initiating polymerization of the reaction mixture;

wherein the first olefin is different than the second olefin and the polyolefin resin has a density greater than about 0.92, a melt index from about 0.01 to about 20, and a long chain branching index of greater than about 1. Typically, the reaction temperature will be from about 60° C. to about 90° C. The method of this embodiment is preferably carried out at pressure less than about 1000 psig. The preferred catalyst system does not contain chromium. The phrase “does not contain chromium” in this context means that chromium is present at most as impurities or in a trace amount. Moreover, the preferred catalyst system is a vanadium-containing catalyst system. The most preferred catalyst systems are those disclosed in U.S. Pat. No. 5,534,472, the entire disclosure of which is hereby incorporated by reference. Although not limiting the present invention to any particular mechanism, it is believed that the polymers made by the method of the invention have long chain branched by the activation of C—H bonds in the polymer backbone through a σ- bond metathesis reaction followed by insert of an ethylene or an α-olefin. The most preferred catalyst system comprises:

(A) a supported catalyst component prepared by the steps of

(i) preheating silica at a temperature in the range of between about 150° C. and about 800° C.;

(ii) contacting said preheated silica with a contacting agent selected from the group consisting of (1) a compound or complex which includes at least one carbon to magnesium covalent bond, (2) a compound which includes at least one carbon to a metal of Group III of the Periodic Table of the Elements covalent bond and (3) both a compound or complex which includes at least one carbon to magnesium covalent bond and a compound which includes at least one carbon to Group III metal covalent bond;

(iii) contacting said product of step (ii) with whichever of contacting agent (1) and (2) that does not contact said preheated silica in step (b), with the proviso that this step is omitted if said contacting agent (3) is employed in step (b);

(iv) contacting said product of step (ii) or (iii) with a vanadium compound which includes at least one halogen atom; and

(v) contacting said product of step (iv) with an alcohol;

(B) an organoaluminum compound cocatalyst; and

(C) a halogen-containing promoter compound having the structural formula Cₜ, Hₛ, X²₂ₜ₊₂₋ₛ where X² is the same or different and is fluorine, chlorine or bromine; t is an integer of 1 to 3 and s is 0 or an integer of 1 to 7; and

b) initiating polymerization of the reaction mixture;

The first olefin is different than the second olefin. Moreover, the amount of the second olefin is somewhat important in determining the properties of the polyolefin resin formed by the method of the invention. The resulting polyolefin resin has a density greater than about 0.92, a melt index from about 0.01 to about 20, and a long chain branching index of greater than about 1. In one variation of this embodiment, the melt index is from about 0.1 to 10. In another variation of this embodiment, the chain branching index is from about 1 to 6. In still another variation of this embodiment, the chain branching index is from about 2 to 3.

A number of different α-olefins may be used in practicing the invention. For example, first olefin and the second olefin are each selected from the group consisting of ethylene, propylene, 1-butene, 1-pentene, 4-methyl-1-pentene, 1-hexene, 1-octene, and mixtures thereof. Preferably, the first olefin is ethylene and the second olefin is 1-butene, 1-hexene, or mixtures thereof. The molar ratio of the first olefin to the second olefin is preferably from about 0.001 to about 1,000. Moreover, the first olefin is present in an amount of about 0.2 mole % to about 20 mole % of the reaction mixture and the second olefin is present in an amount of about 0.1 mole % to about 30 mole % of the reaction mixture.

In a first variation of this embodiment of the present invention when the most preferred vanadium-containing catalyst system is used, the first olefin is present in an amount of about 5 mole % to about 15 mole % of the reaction mixture and the second olefin is present in an amount of about 0.5 mole % to about 5 mole % of the reaction mixture. In this variation, when the first the first olefin is ethylene, the polyolefin formed by the method of the invention will be a HDPE. In another variation of this embodiment when the most preferred vanadium-containing catalyst system is used, the first olefin is present in an amount of about 5 mole % to about 15 mole % of the reaction mixture and the second olefin is present in an amount of about 5 mole % to about 30 mole % of the reaction mixture. In this variation, when the first olefin is ethylene, the polyolefin resin formed by the method of the invention is a LLDPE.

The reaction mixture used in the method of the invention also includes molecular hydrogen preferably in an amount from about 0.00005 to about 5 mole %. The amount of hydrogen will most significantly affect the molecular weight of the polyolefin resins formed by the invention. For example, low molar percentages of hydrogen from about 0.00005 to 0.5 mole % will tend to form high molecular weight polymers. More preferably about 0.01 mole % hydrogen of the reaction mixture is used to produce high molecular weight resins. When a low molecular weight resin is desired, hydrogen is present from about 0.5 mole % to about 5 mole %. More preferably, the hydrogen will be present in an amount from about Imole % to about 3 mole % is a low molecular weight resin is desired.

The vanadium-containing catalyst system of the present invention includes an organoaluminum compound cocatalyst. The vanadium-containing catalyst systems also includes a promoter which improves the activity of the catalyst while also possibly modifying the molecular weight distribution. Finally, the vanadium-containing catalyst systems optionally includes a modifier having formula I:

(R¹O)ₓSiR²₄₋ₓ I

where R¹ and R² are each independently alkyl and x is 1 to 3. The modifier is useful in tailor the molecular weight distribution and long chain branching of the polyolefins resins of the present invention. The modifier is added at any point during the formation of the polyolefin resin. Suitable modifiers include for example (i-propyl)₂Si(OMe)₂, (i-butyl)₂Si(OMe)₂, Me₂Si(OMe)₂, (i-butyl)Si(OMe)₃, (cyclohexyl)(Me)Si(OMe)₂, and the like.

The method by which the polymerization that occurs in the method of the invention is initiated merits some discussion. The polymerization may be carried out in a continuous or batch-wise reactor system. Typically, the reaction mixture is formed by charging a reaction vessel with the diluent, molecular hydrogen, and optionally one or both of the first olefin and the second olefin. The exact order with which these components are added is not very critical. Polymerization may be initiated by introducing the catalyst system into the reaction vessel followed by addition of the first olefin and the second olefin if either has not already been added. In a variation of this polymerization initiation, the organoaluminum compound cocatalyst, the modifier, and the halogen-containing promoter are also added to the reaction mixture prior to initiation by the supported catalyst component.

In yet another embodiment of the invention, a method of forming a polyolefin resin is provided. Moreover, the method of this embodiment can be separated into two discrete parts making it suitable to be carried out in a cascading reactor system having at least two zones or reaction chambers. A two reactor system will typically have a conduit connecting the reactor so that the contents of on reactor can be transferred to the second reactor. The specific temperatures and concentrations of olefins and H₂ used in each reactor are chosen to produce the desired molecular weight, density, and long chain branching index of the polymers. The first part of this method which may be carried out is a first zone or reactor comprises forming a reaction mixture at a sufficient temperature to allow formation of the polyolefin resin by combining molecular hydrogen, a first olefin selected from the group consisting of ethylene and a C₃-C₈ α-olefin, an optional diluent, a second olefin selected from the group consisting of ethylene and a C₃-C₈ α-olefin, an optional diluent, and a catalyst system that forms long chain branches on a polymer backbone. The first olefin is different than the second olefin. The method of this embodiment is preferably carried out at pressure less than about 1000 psig. The preferred catalyst systems are the same as set forth above. Similarly, the selection of the first olefin and the vanadium-containing catalyst system is the same as set forth above. At this point, one or more of the first olefin, the second olefin, molecular hydrogen, and the diluent may be optionally removed. If a two reactor system is used, these compound may be removed in a flash vessel that connects the two reactors. In the second part of this method which can be performed in a second zone or reactor, a second olefin selected from the group consisting of ethylene and C₃-C₈ α-olefin is added to the reaction mixture. Additional amounts of the first olefin and molecular hydrogen are added to the reaction mixture if needed. Furthermore, additional amounts of the second olefin and the diluent may also be optionally added. Finally, additional cocatalyst or promoter may also be added at this point. The modifier may be introduced at any step in the method, however, it is preferably introduced in step c. The introduction of the second olefin and the additional amounts of the first olefin may be formed in any order or even simultaneously. The introduction of these olefins causes additional polymerization to occur. Moreover, the resulting polyolefin resin has a density greater than about 0.92, a melt index from about 0.01 to about 20, and a long chain branching index greater than about 1. In one variation of this embodiment, the melt index is from about 0.1 to 10. In another variation of this embodiment, the chain branching index is from about 1 to 6. In still another variation of this embodiment, the chain branching index is from about 2 to 3. In this second embodiment, the first olefin and the second olefin will be the same as set forth above with the same mole ratios as set forth above. Similarly, the amounts of the first and second olefins will be the same as set forth above with the proviso that the amounts of each refers to the total amounts added for all the steps of this embodiment.

In a still another embodiment of the present invention, a method of forming a polyethylene resin is provided. The method of this embodiment comprises forming a reaction mixture by combining molecular hydrogen, ethylene, a C₃-C₈ α-olefin selected from the group consisting of propylene, 1-butene, 1-pentene, 4-methyl-1-pentene, 1-hexene, 1-octene, and mixtures thereof, a diluent, and a vanadium-containing catalyst system at a sufficient temperature to allow formation of the polyolefin resin. The vanadium-containing catalyst is the same as set forth above. The molar ratio of the ethylene to the C₃-C₈ α-olefin is from about 0.001 to about 1,000, the molecular hydrogen is present in amount from about 0.00005 to about 5 mole %, and the polyolefin resin has a density greater than about 0.92, a melt index from about 0.01 to about 20, and a long chain branching index greater than about 1. In one variation of this embodiment, the melt index is from about 0.1 to 10. In another variation of this embodiment, the chain branching index is from about 1 to 6. In still another variation of this embodiment, the chain branching index is from about 2 to 3.

The following examples illustrate the various embodiments of the present invention. Those skilled in the art will recognize many variations that are within the spirit of the present invention and scope of the claims.

### Polymerization Procedures

The catalyst systems of U.S. Pat. No. 5,534,472 as set forth above are used in the following experiments. The cocatalyst in these experiments is Al(Et)₃ (“TEAL”) and the promoter is CH₂Br₂ (“DBM”). All polymerizations are carried out in a 1-gallon polymerization vessel operating in a semi-batch mode. The reactor is fitted with temperature control, pressure control and equipment to introduce, diluents such as isobutane or hexane, molecular hydrogen, monomers such as 1-hexene or 1-butene, catalyst, cocatalyst, and promoter. An ethylene mass flow meter is used to monitor the ethylene consumed during the polymerization, ethylene is added continuously during the run to main a constant concentration. All other ingredients are added at the beginning of the run.

1. Single Reactor HDPE Experiments

The N₂ purged reactor is sealed and then the following are added as follows. H₂ as an amount from a 500 ml vessel and added to the reactor as a pressure drop to control the MI to the desired level. Typically from 10 to 750 psi pressure drop. 1600 ml of isobutane as the diluent. The stirrer is turned on and the temperature control set to 80° C. Optionally, a quantity of 1-hexene or 1-butene is added to produce the target density (for higher density typically 10-100 mls) The catalyst, cocatalyst, and modifier are added to a 3-legged injector device in an inert atmosphere glove box. The injector is connected to the reactor through a quick connect to avoid contamination with water and oxygen. A high-pressure N₂ line is connected to aid in adding the materials. The cocatalyst TEAL typically 1-2 mls of a ˜1.5M solution in heptane is injected into the reactor. Then DBM solution typically 1-6 mls of a 1M of DBM solution in heptane are added. The ethylene is then added to the reactor to ˜5 psi pressure below the desired run pressure as the reactor stabilizes at run temperature.

The catalyst typically 0.1 to 0.5 grams is injected to initiate the run. As soon as the catalyst is injected the run time is started and the ethylene is turned on. Typical runs may produce 100-300 grams of polymer. To minimize the impact of H₂ or comonomer concentration changes during the runs each run is targeted to make ˜100 grams of polymer. When the ethylene totalizer indicates ˜100 grams of polymer are made the run is terminated by turning off the ethylene supply and dumping the reactor contents through a bottom dump valve into a receiving vessel. The volatile reactants are vaporized through a suitable vent stack to the atmosphere.

2. Single Reactor LLDPE Experiment

These experiments follow the same procedure as the HDPE experiments above except as noted below. A lower polymerization temperature typically 60-80° C. would be used to avoid reactor fouling. A larger volume of comonomer would be used typically 100-600 mls of either 1-butene or 1-hexene to produce the desired density. The amount of H₂ would be adjusted to produce the desired MI.

3. Cascade Reactor Simulation—General Procedure

Simulated cascade reactor runs are used to allow targeting of either molecular weight (MI), long chain branching, and/or comonomer to produce a desired polymer. These runs are conducted in the same 1 gallon reactor described above.

Reactor Conditions for the First Stage of Polymerization.

Add the ingredients as described for single reactor HDPE Experiments. However, the polymerization is run until 100 grams of polymer are made. The reactor pressure is then vented down to the vapor pressure of isobutane at the run temperature. The polymer and isobutane remain in the reactor.

Reactor Conditions for the Second Stage of Polymerization.

The new run conditions are inventoried as need, e.g. hexene, H₂, and ethylene. The run is typically run for 100 gram additional yield. The amount of polymer made under each set of conditions is controllable to make the desired polymer properties. No additional catalyst is added. Optionally, additional cocatalyst or promoter may be added.

4. Cascade Reactor Simulation—Actual Experiment

In these examples (2-4), a polymer is formed by simulating a cascade reactor. Specifically the comonomer is targeted to the high Mw side of the MWD. The examples explore a range of hexene utilized thus offering a range of density of the resin produced.

Reactor Conditions for the First Stage of Polymerization.

The 1^{st} stage is simulated by maintaining the reactor at a temperature of about 80° C. Approximately, 0.169 grams of catalyst, 2 mls of 1.5M TEAL, and 3 mls of 10M DBM were charged to the catalyst, cocatalyst, and modifier injectors respectively in the glove box. The injector was connected to the reactor. 1600 mls of isobutane diluent were added to the reactor. Next 100 psi delta P of H₂ were added from the addition vessel. The reactor was brought up to temperature as the TEAL & DBM were injected to the reactor. The ethylene was added to give a final pressure of 326 psi. The catalyst was injected and the run continued to produce about 100 grams of polymer. The reactor was then vented to 200 psi (vapor pressure of isobutane) to remove ethylene and H₂.

Reactor Conditions for the Second Stage of Polymerization.

The reactor was maintained at temperature and rapidly 10 ml of 1-hexene, 50 psi pressure drop of H₂ and ethylene to a final pressure of 326 psi were added. The run continued to produce about 100 grams of additional polymer. Upon completion of the run, the ethylene feed was stopped and the reactor was rapidly discharged to a dump vessel to remove the volatile gases.

The polymer was vacuum oven dried to remove residual hexene before further analysis. The material was stabilized with antioxidants and the MI & HLMI were measured by ASTM method D1238 with conditions of MI 190° C. 2.16 kG and HLMI 21.6 kg respectively. The results are MI=0.21 and HLMI=76.

Table 1 provides reaction condition and ingredients for polyolefin composition made by the methods of the present invention. Table 2 provides samples made by the methods of the invention. Example 1 is a single reactor simulation showing the production of a higher melt index (“MI”) material with significant LCBI. Examples 2-4 provides the run conditions for the cascade simulation.

TABLE 1
Reaction conditions.

| | | Total | | | | |
|---|---|---|---|---|---|---|
| | | reactor | Stage 1 | Stage 2 | Stage 1 | Stage 2 |
| | Tem- | pressure | H2 | H2 | volume of | volume of |
| Exam- | perature | (ethylene | pressure | pressure | 1-hexene | 1-hexene |
| ple | (° C.) | included) | (psi) | (psi) | (ml) | (ml) |
| 1 | 100 | 450 | 50 | NA* | 0 | NA |
| 2 | 80 | 335 | 100 | 50 | 0 | 10 |
| 3 | 80 | 335 | 100 | 50 | 0 | 30 |
| 4 | 80 | 335 | 100 | 50 | 0 | 50 |

*NA means not applicable.

TABLE 2
Polyolefin resin properties.

| | Melt Index (g/10 | | |
|---|---|---|---|
| Sample ID | min) | Melt Index Ratio | LCBI |
| 1 | 9.5 | — | >5 |
| 2 | 0.33 | 243 | 1.68 |
| 3 | 0.57 | 218 | 2.62 |
| 4 | 0.713 | 223 | 2.57 |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A polyolefin resin comprising:
a polymer resin formed by polymerization of reaction mixture comprising a first olefin selected from the group consisting of ethylene and C₃-C₈ α-olefin, a catalyst system that forms long chain branches on a polymer backbone, and an optional second olefin selected from the group consisting of ethylene and C₃-C₈ α-olefin, wherein the first olefin is different than the second olefin and the polymer resin having a density greater than about 0.92, a melt index from about 0.01 to about 20, and a long chain branching index of greater than about 1.

2. The polyolefin resin of claim 1 wherein the catalyst system does not contain chromium.

3. The polyolefin resin of claim 1 wherein the melt index is from about 0.1 to about 10.

4. The polyolefin resin of claim 1 wherein the long chain branching index is from about 1 to about 6.

5. The polyolefin resin of claim 1 wherein the long chain branching index is from about 2 to about 3.

6. The polyolefin resin of claim 1 wherein the first olefin and the second olefin are each selected from the group consisting of ethylene, propylene, 1-butene, 1-pentene, 4-methyl-1-pentene, 1-hexene, 1-octene, and mixtures thereof.

7. The polyolefin resin of claim 1 wherein the molar ratio of the first olefin to the second olefin in the reaction mixture is from about 0.001 to about 1,000.

8. The polyolefin resin of claim 1 wherein,
the first olefin is present in an amount of about 0.2 mole % to about 20 mole % of the reaction mixture; and
the second olefin is present in an amount of about 0.1 mole % to about 30 mole % of the reaction mixture.

9. The method of claim 1 wherein the reaction mixture includes molecular hydrogen present in an amount of about 0.00005 mole % to about 5 mole % of the reaction mixture.

10. The polyolefin resin of claim 1 wherein,
the first olefin is present in an amount of about 5 mole % to about 15 mole % of the reaction mixture; and
the second olefin is present in an amount of about 0.5 mole % to about 5 mole % of the reaction mixture.

11. The polyolefin resin of claim 10 wherein the first olefin is ethylene, the second olefin is selected from the group consisting of ethylene, propylene, 1-butene, 1-pentene, 4-methyl-1-pentene, 1-hexene, 1-octene, and mixtures thereof, and the polyolefin resin is a HDPE.

12. The polyolefin resin of claim 1 wherein,
the first olefin is present in an amount of about 5 mole % to about 15 mole % of the reaction mixture; and
the second olefin is present in an amount of about 5 mole % to about 30 mole % of the reaction mixture.

13. The polyolefin resin of claim 10 wherein the first olefin is ethylene, the second olefin is selected from the group consisting of ethylene, propylene, 1-butene, 1-pentene, 4-methyl-1-pentene, 1-hexene, 1-octene, and mixtures thereof, and the polyolefin resin is a LLDPE.

14. A method of forming a polyolefin resin, the method comprising:
a) forming a reaction mixture at a sufficient temperature to allow formation of the polyolefin resin by combining molecular hydrogen, a first olefin selected from the group consisting of ethylene and C₃-C₈ α-olefin, an optional second olefin selected from the group consisting of ethylene and C₃-C₈ α-olefin, a diluent, and a catalyst system; and
b) initiating polymerization of the reaction mixture;
wherein the first olefin is different than the second olefin and the polyolefin resin has a density greater than about 0.92, a melt index from about 0.01 to about 20, and a long chain branching index of greater than about 1.

15. The method of claim 14 wherein the catalyst system does not contain chromium.

16. The method of claim 14 wherein the first olefin and the second olefin are each selected from the group consisting of ethylene, propylene, 1-butene, 1-pentene, 4-methyl-1-pentene, 1-hexene, 1-octene, and mixtures thereof.

17. The method of claim 14 wherein the molar ratio of the first olefin to the second olefin is from about 0.001 to about 1,000.

18. The method of claim 14 wherein,
the first olefin is present in an amount of about 0.2 mole % to about 20 mole % of the reaction mixture; and
the second olefin is present in an amount of about 0.1 mole % to about 30 mole % of the reaction mixture.

19. The method of claim 14 wherein the molecular hydrogen is present in an amount of about 0.00005 to about 5%.

20. The method of claim 14 wherein the catalyst system is a vanadium-containing catalyst system, the vanadium-containing catalyst system comprising:
(A) a supported catalyst component prepared by the steps of
(i) preheating silica at a temperature in the range of between about 150° C. and about 800° C.;
(ii) contacting said preheated silica with a contacting agent selected from the group consisting of (1) a compound or complex which includes at least one carbon to magnesium covalent bond, (2) a compound which includes at least one carbon to a metal of Group III of the Periodic Table of the Elements covalent bond and (3) both a compound or complex which includes at least one carbon to magnesium covalent bond and a compound which includes at least one carbon to Group III metal covalent bond;
(iii) contacting said product of step (ii) with whichever of contacting agent (1) and (2) that does not contact said preheated silica in step (b), with the proviso that this step is omitted if said contacting agent (3) is employed in step (b);
(iv) contacting said product of step (ii) or (iii) with a vanadium compound which includes at least one halogen atom; and
(v) contacting said product of step (iv) with an alcohol;
(B) an organoaluminum compound cocatalyst; and
(C) a halogen-containing promoter compound having the structural formula Cₜ, Hₛ, X²₂ₜ₊₂₋ₛ where X² is the same or different and is fluorine, chlorine or bromine; t is an integer of 1 to 3 and s is 0 or an integer of 1 to 7; and
b) initiating polymerization of the reaction mixture;
wherein the first olefin is different than the second olefin and the polyolefin resin has a density greater than about 0.92, a melt index from about 0.01 to about 20, and a long chain branching index of greater than about 1.

21. The method of claim 20 wherein,
the first olefin is present in an amount of about 5 mole % to about 15 mole % of the reaction mixture; and
the second olefin is present in an amount of about 0.5 mole % to about 5 mole % of the reaction mixture.

22. The method of claim 21 wherein the olefin is ethylene, the second olefin is selected from the group consisting of ethylene, propylene, 1-butene, 1-pentene, 4-methyl-1-pentene, 1-hexene, 1-octene, and mixtures thereof, and the polymer is a HDPE.

23. The method of claim 20 wherein,
the first olefin is present in an amount of about 5 mole % to about 15 mole % of the reaction mixture; and
the second olefin is present in an amount of about 5 mole % to about 30 mole % of the reaction mixture.

24. The method of claim 23 wherein the first olefin is ethylene, the second olefin is selected from the group consisting of ethylene, propylene, 1-butene, 1-pentene, 4-methyl-1-pentene, 1-hexene, 1-octene, and mixtures thereof, and the polymer is a LLDPE.

25. The method of claim 20 wherein the organoaluminum compound cocatalyst is Al(Et)₃ and the halogen containing promoter is CH₂Br₂.

26. The method of claim 20 wherein the vanadium-containing catalyst systems further includes a modifier having formula I:
(R¹O)ₓSiR²₄₋ₓ I
where R¹ and R² are each independently alkyl and x is 1 to 3, wherein the modifier is added at any point during the formation of the polyolefin resin.

27. The method of claim 24 wherein the modifier is a component selected from(i-propyl)₂Si(OMe)₂, (i-butyl)₂Si(OMe)₂, Me₂Si(OMe)₂, (i-butyl)Si(OMe)₃, (cyclohexyl)(Me)Si(OMe)₂, and mixtures thereof.

28. A method of forming a polyolefin resin, the method comprising:
a) forming a reaction mixture at a sufficient temperature to allow formation of the polyolefin resin by combining molecular hydrogen, a first olefin selected from the group consisting of ethylene and a C₃-C₈ α-olefin, an optional diluent, a second olefin selected from the group consisting of ethylene and a C₃-C₈ α-olefin, an optional diluent, and a catalyst system that forms long chain branches on a polymer backbone, wherein the first olefin is different than the second olefin;
b) optionally removing one or more of the first olefin, the second olefin, molecular hydrogen, and the diluent; and
c) introducing additional amounts of molecular hydrogen, the first olefin, and optionally, the second olefin and the diluent,
wherein additional polymerization occurs in step c and the polyolefin resin has a density greater than about 0.92, a melt index from about 0.01 to about 20, and a long chain branching index of about 1 to about 6.

29. The method of claim 28 wherein the catalyst system does not contain chromium.

30. The method of claim 28 wherein the first olefin and the second olefin are each selected from the group consisting of ethylene, propylene, 1-butene, 1-pentene, 4-methyl-1-pentene, 1-hexene, 1-octene, and mixtures thereof.

31. The method of claim 28 wherein the molar ratio of the first olefin to the second olefin is from about 0.001 to about 1,000.

32. The method of claim 28 wherein,
the first olefin is present in an amount of about 0.2 mole % to about 20 mole % of the reaction mixture; and
the second olefin is present in an amount of about 0.1 mole % to about 30 mole % of the reaction mixture.

33. The method of claim 28 wherein the molecular hydrogen is present in an amount of about 0.00005 to about 5%.

34. The method of claim 28 wherein the catalyst system is a vanadium-containing catalyst system comprising:
(A) a supported catalyst component prepared by the steps of
(i) preheating silica at a temperature in the range of between about 150° C. and about 800° C.;
(ii) contacting said preheated silica with a contacting agent selected from the group consisting of (1) a compound or complex which includes at least one carbon to magnesium covalent bond, (2) a compound which includes at least one carbon to a metal of Group III of the Periodic Table of the Elements covalent bond and (3) both a compound or complex which includes at least one carbon to magnesium covalent bond and a compound which includes at least one carbon to Group III metal covalent bond;
(iii) contacting said product of step (ii) with whichever of contacting agent (1) and (2) that does not contact said preheated silica in step (b), with the proviso that this step is omitted if said contacting agent (3) is employed in step (b);
(iv) contacting said product of step (ii) or (iii) with a vanadium compound which includes at least one halogen atom; and
(v) contacting said product of step (iv) with an alcohol;
(B) an organoaluminum compound cocatalyst;
(C) a halogen-containing promoter compound having the structural formula Cₜ Hₛ X²₂ₜ₊₂₋ₛ where X² is the same or different and is fluorine, chlorine or bromine; t is an integer of 1 to 3 and s is 0 or an integer of 1 to 7; and
(D) an optional having formula I:
(R¹O)ₓSiR²₄₋ₓ I
where R¹ and R² are each independently alkyl and x is 1 to 3; and

35. The method of claim 34 wherein,
the first olefin is present in an amount of about 5 mole % to about 15 mole % of the reaction mixture; and
the second olefin is present in an amount of about 0.5 mole % to about 5 mole % of the reaction mixture.

36. The method of claim 35 wherein the olefin is ethylene, the second olefin is selected from the group consisting of ethylene, propylene, 1-butene, 1-pentene, 4-methyl-1-pentene, 1-hexene, 1-octene, and mixtures thereof, and the polymer is a HDPE.

37. The method of claim 34 wherein,
the first olefin is present in an amount of about 5 mole % to about 15 mole % of the reaction mixture; and
the second olefin is present in an amount of about 5 mole % to about 30 mole % of the reaction mixture.

38. The method of claim 37 wherein the first olefin is ethylene, the second olefin is selected from the group consisting of ethylene, propylene, 1-butene, 1-pentene, 4-methyl-1-pentene, 1-hexene, 1-octene, and mixtures thereof, and the polymer is a LLDPE.

39. The method of claim 37 wherein the organoaluminum compound cocatalyst is Al(Et)₃ and the halogen containing promoter is CH₂Br₂.

40. The method of claim 34 wherein the vanadium-containing catalyst systems further includes a modifier having formula I:
(R¹O)ₓSiR²₄₋ₓ I
where R¹ and R² are each independently alkyl and x is 1 to 3, wherein the modifier is added at any point during the formation of the polyolefin resin.

41. The method of claim 34 wherein the modifier is added during step c.

41. The method of claim 28 wherein the reaction mixture is formed by charging a reaction vessel with the first olefin, the second olefin, the molecular hydrogen, the organoaluminum compound cocatalyst, and the halogen-containing promoter and then initiating the polymerization to form the polyolefin resin by introducing the supported catalyst component into the reaction vessel.
